(19) United States
(12) Patent Application Publication
(10) Pub. No.: US 2022/0198474 A1
(43) Pub. Date: Jun. 23, 2022

(54) OPTIMIZATION OF PROVIDING TECHNICAL SERVICES

(71) Applicant: International Business Machines Corporation, Armonk, NY (US)

(72) Inventors: Lisa Seacat DeLuca, Bozeman, MT (US); Jonathan Tristan O'Gorman, Whitegate (IE)

(21) Appl. No.: 17/127,815

(22) Filed: Dec. 18, 2020

(51) Int. Cl. G06Q 30/02; G06Q 10/06; G06Q 10/04; G06N 20/00; H04W 4/029

(52) U.S. Cl. CPC G06Q 30/02; G06Q 10/06; H04W 4/029; G06N 20/00; G06Q 10/047

(57) ABSTRACT

Information about a technician is received, in which the information includes an area expertise, a skill level, qualifications, available tools and materials, a previously performed service history and a location of the technician. A plurality of service request candidates is received that includes information associated with respective service requests. A first set of service requests appropriate for the technician is identified by comparing the information about the technician and the current location of the technician to the plurality of service request candidates. A recommended order to perform the first set of service requests is determined, based on a distance between service request locations, urgency of performing the service request, and factors associated with the respective service request; and a map representation of relative locations and the recommended order of service request response for the first set of service requests is presented to the technician.

### FIELD OF THE INVENTION

The present invention relates generally to the field of asset management solutions, and more particularly to work assignment optimization.

### BACKGROUND OF THE INVENTION

Enterprise businesses strive to improve the deployment of human and equipment assets to optimize the revenue received from applying assets to work requests in a manner that maximizes the completion of work requests per unit of time. Often, the selection of work requests is left to the pool of responders, herein referred to as technical service providers, or technicians, to select and manage.

Work requests often include a problem description or a set of outcome requirements and may have historic instances of similar requests with a service-provider business providing technical skills and assets. In some cases, a technical service provider may have multiple work requests to address involving various types of requests, at random locations, and undefined scheduling.

### SUMMARY

Embodiments of the present invention disclose a method, computer program product, and system for aligning appropriate service requests to a technician as a provider of services. The method provides for one or more processors to receive information about a technician, wherein the information includes an area of expertise, a skill level, documented qualifications, a set of tools and materials available to the technician, a history of previously performed service instances by the technician, and a location of the technician. The one or more processors receive a plurality of service request candidates in which respective service requests include information associated with respective service requests. The one or more processors identify a first set of service requests appropriate for the technician by comparing the information about the technician and the current location of the technician to the plurality of service request candidates. The one or more processors determine a recommended order in which the first set of service requests are performed by the technician, based on a distance between service request locations, the urgency of performing the service request, and factors associated with the respective service request; and the one or more processors present a map representation of relative locations and the recommended order of service request response for the first set of service requests to the technician.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting the operational steps of a service alignment program operating in the distributed data processing environment of FIG. 1, in accordance with embodiments of the present invention.

FIG. 3 depicts a block diagram of components of a computing system, including a computing device configured to operationally perform the service alignment program of FIG. 2, in accordance with an embodiment of the present invention.

### DETAILED DESCRIPTION

Embodiments of the present invention recognize that users in roles as service providers travel from service request to service request, using a transportation vehicle as a mobile office. Service providers often individually select the service requests to perform, and seldom consider an optimized order in which to perform service requests. Embodiments recognize that a service provider can select service requests that require skill beyond the provider's capability, risking failure to complete the service request or requiring unplanned assistance.

Embodiments also recognize that a service provider may select service requests that are simple and don't require the skill and experience level of a responding service provider, leaving more difficult and complex service requests in the hands of service providers that are less experienced or are under-skilled. Embodiments of the present invention recognize that the mismatch between the capability of the service provider hereafter referred to as a technician, and the skill and experience needed to successfully complete the service request results in delays in completing the service request, possibly lower quality performance of the service request, requests for additional technician support, and wasting of high-level skills on menial service tasks. Embodiments recognize the need for a solution that considers the skill and expertise of the service provider and matches the providers to service requests estimated or known to require a certain skill and expertise levels, as well as tools, materials, and parts known as required for the particular service request.

The term “technician,” as referred to herein, is a label given to a provider of service having an acknowledged skill level and qualifications in an area of expertise that may be supported by certifications, education, and experience. The skill level and degree of qualification as well as the number of areas of expertise and experience may differentiate capabilities and limitations among technicians. In some embodiments, the technician may be in a role as a customer service representative, help desk provider, or other assisting or problem-solving position responding to requests for service.

Embodiments of the present invention provide a method, computer program product, and computer system for aligning appropriate service requests to a technician as a provider of services, the alignment based on matching the area(s) of expertise, experience, qualifications, location, and service performance history of a respective technician to a set of service requests in which the type of service and requirements of the service are generally known from an aggregate of historical performances. In some embodiments, a machine learning model is applied to the service performance history of a respective technician, in which the model learns a skill level and experience of the technician in a particular area of providing service to assets.

In some embodiments an asset may be but are not limited to, an appliance or equipment requiring repair, maintenance, upgrade, replacement, or diagnosis. In some embodiments, assets may belong to a type of assets, such as heating, ventilation, and air conditioning (HVAC) units, household appliances, commercial appliances, computing systems, and networks, for example. In some embodiments, assets are additionally identified by brand and model. In some embodiments, assets may be included in a class of service, such as “all plumbing”, “electrical services”, “communications services,” or “computer component integration.”

In some embodiments of the present invention, information about technicians is collected and can include qualifications, certifications, education levels and courses, one or more areas of service expertise, skill level, work history, tool training, and technician location. Information regarding qualifications and certifications may include records of training completion or experience based on work history. Skill levels may be self-assessments, third-party assessments, or demonstrated attainment of documented standardized skill levels. In some embodiments, technician work history includes a number of service instances performed, type of service performed, asset type, brand, model, asset class, worksites, service duration, first-time fix rate, special tools, parts, or materials used, and results of service performed, including feedback from customers.

Embodiments of the present invention include receiving a plurality of service requests. In some embodiments, service requests include information regarding the service to be performed, a location at which the service is to be performed, a requested timeframe or level of urgency, and may include conditions in which the service is to be performed. For example, the service request may identify an asset and a problem or condition of the asset requiring service. In some embodiments, the required service may be known and well defined, such as a scheduled maintenance service request of an HVAC unit. In other embodiments, the service request may include a description of symptoms and data that is sufficient to determine the service requirements. In yet other embodiments, the service request may require examination and diagnosis to determine the specific service required. In some embodiments, the location of the service request may include special access conditions for security or safety-related reasons, such that technicians responding to service requests at the location may have to complete prior background checks, interviews, agreements, or may have to possess and use specialized equipment for personal safety or safety of the location.

In some embodiments of the present invention, machine learning (ML) techniques are applied to the aggregate information of respective technicians. The techniques may include supervised and unsupervised training, based on the technician information gathered, to generate a model to determine a technician profile of capabilities and limitations that distinguish the respective technicians. The generated ML model determines the area of expertise of the technician, a level of skill and experience of asset classes and asset details, based on work history, use of specialized tools, prior worksites of the technician, and location of the technician. The ML model may also include technician service measurements, such as “first-time fix rate” for an asset or across and asset class. In embodiments of the present invention, the plurality of received service requests are compared with known service requirements and conditions for the type of request (e.g., from historical records of the type of service request), and the ML model profile information of the technicians, to optimally align technicians to service requests.

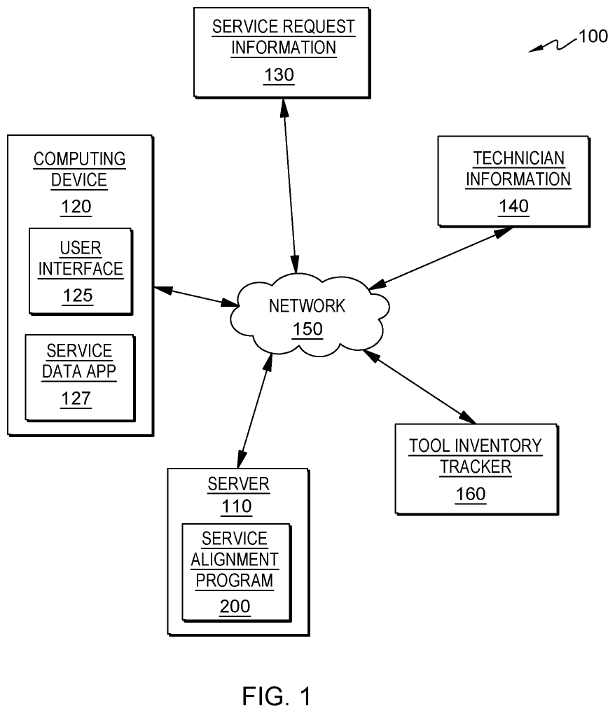

The present invention will now be described in detail with reference to the Figures. FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 110, computing device 120, service request information 130, technician information 140, and tool inventory tracker 160, all interconnected via network 150. Network 150 can be, for example, a local area network (LAN), a wide area network (WAN), such as the Internet, a virtual local area network (VLAN), or any combination that can include wired, wireless, or optical connections. In general, network 150 can be any combination of connections and protocols that will support communication and data transmission between server 110, computing device 120, service request information 130, technician information 140, and tool inventory tracker 160.

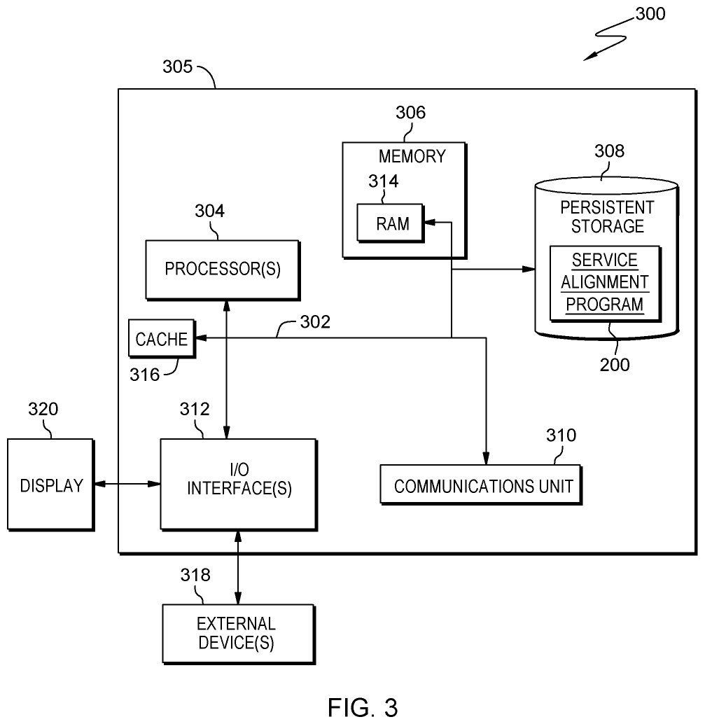

Server 110 includes service alignment program 200. In some embodiments, server 110 can be a blade server, a web server, a laptop computer, a desktop computer, a standalone mobile computing device, a smartphone, a tablet computer, or another electronic device or computing system capable of receiving, sending, and processing data. In other embodiments, server 110 may be a computing device interacting with applications and services hosted and operating in a cloud computing environment. In another embodiment, server 110 can be a netbook computer, a personal digital assistant (PDA), or other programmable electronic devices capable of generating and transmitting input to and receiving programming instructions from order management system 115 and alternate return program 200. Alternatively, in some embodiments, server 110 may be communicatively connected to alternate return program 200 operating remotely. Server 110 may include internal and external hardware components, depicted in more detail in FIG. 3.

Service alignment program 200 receives information about technicians from technician information 140, tool availability and technician training on tools from tool inventory tracker 160, and information associated with requests for service from service request information 130. Service alignment program 200 determines the area of expertise for a given request for service as well as the level of skill and qualifications required to perform the service and other factors associated with the particular request for service, such as location, site conditions, special tool requirements, and urgency. Service alignment program 200 optimizes the alignment of candidate service requests to the respective capabilities of the service technicians. Service alignment program 200 performs the optimization by comparing the service request information and requirements to the technician information and performs a best-match assignment of a set of service requests to respective technicians that are appropriate for the capabilities and performance history of the technician.

In some embodiments of the present invention, service alignment program 200 is an extension of an asset management application enabling optimized assignment of a pool of technician service providers to a plurality of service requests. In some embodiments, service alignment program 200 is a server-based program operating in a cloud environment and communicatively connected to technician mobile devices by an application (app) installed on the mobile device that displays service request information to the respective technician, appropriate for the technician. Appropriate service requests and associated information for a particular technician are service requests that include conditions and requirements that match or are acceptably aligned with the capabilities and work performance record of the technician.

In some embodiments, the service request information received by service alignment program 200 includes a location at which the service is to be performed, a description of the service to be performed, or a description of a problem or symptoms related to the request. The service request information may include a requested timeframe for the service or may indicate a level of urgency, such as routine maintenance or emergency needs.

In some embodiments, service alignment program 200 determines if the service request indicates the need for a particular tool, equipment, parts, or materials, based on historic data associated with similar service requests on similar assets. In some embodiments, service alignment program 200 receives a location within the service request information and determines whether the service request site has access or operational conditions that must be met by technicians responding to service requests, such as security clearance, certification of safety training, use of safety devices or safety protective apparel.

In some embodiments, service alignment program 200 determines service requests selected by a technician from a set of service requests determined to be appropriate for the technician. Service alignment program 200 provides a recommended order in which to perform the service requests based on the location of the technician, the locations associated with the service requests, priorities of the service requests, as well as other factors, such as tools available to the technician and special tools, parts, or materials known to be used in performing certain service requests. In some embodiments, service alignment program 200 provides navigation information to a mobile device of the technician indicating the recommended order and paths to travel for the next service request appointment. In some embodiments, the information regarding a service request for a particular technician is received and stored on the technician's mobile device, enabling the technician to access and interact with the information even in a disconnected mode. When connected, the mobile device can synchronize with service alignment program 200, operating in a cloud environment.

In some embodiments, service alignment program 200 considers additional technician information in determining an order in which to perform the set of service requests and determining the navigation to follow. The additional technician information may include a first-time fix rate for an asset type or asset class, assets previously worked on per service history records, site locations of previously performed service, and determine whether a digital twin of the target asset for service is available.

In some embodiments of the present invention, service alignment program 200 initiates and operates in an automated manner. Service alignment program 200 initiates in response to receiving a set of service requests. The initiation response may include a threshold number of service requests comprising the set of service requests, and in response to exceeding the predetermined number of service requests received, service alignment program 200 performs an analysis of the respective service requests and automatically identifies the technicians whose technician information aligns or aligns most closely with the detailed information of the respective service requests of the received set. Embodiments of the present invention provide an improvement in aligning service-providing technician support with the requirements, conditions, and locations of service requests.

Computing device 120 is a user mobile device capable of performing programmable operations and communicating with other devices of distributed data processing environment 100. Computing device 120 includes user interface 125 and service data app 127. Computing device 120 receives communications from service alignment program 200 operating on server 110, which includes service request information processed and stored by service data app 127 and viewable by the user of computing device 120 via user interface 125. Computing device 120 communicates via network 150 to server 110.

In some embodiments, computing device 120 may be a server computer, a laptop computer, a tablet computer, a smartphone, smartwatch, a wearable computing device, or any programmable electronic mobile device capable of communicating with various components and devices within distributed data processing environment 100, via network 150. In another embodiment, computing device 120 represents a computing system utilizing clustered computers and components (e.g., database server computers, application server computers, etc.) that act as a single pool of seamless resources when accessed within distributed data processing environment 100. In general, computing device 120 represents one or more programmable electronic devices or a combination of programmable electronic devices capable of executing machine-readable program instructions and communicating with server 110, via network 150. Computing device 120 may include internal and external hardware components, depicted in more detail in FIG. 3.

User interface 125 provides an interface to access the features and functions of computing device 120. In some embodiments of the present invention, user interface 125 provides access to operate an application, such as service data app 127, for receiving and storing service request information from server 110 and providing updates to service alignment program 200. User interface 125 may also support access to other applications, features, and functions of computing device 120 (not shown). In some embodiments, user interface 125 provides display output and input functions for computing device 120.

User interface 125 supports access to alerts, notifications, and provides access to forms of communications. In one embodiment, user interface 125 may be a graphical user interface (GUI) or web user interface (WUI) and can receive user input and display text, documents, web browser windows, user options, application interfaces, and instructions for operation, and include the information (such as graphic, text, and sound) that a program presents to a user and the control sequences the user employs to control the program. In another embodiment, user interface 125 may also include mobile application software that provides respective interfaces to features and functions of computing device 120. User interface 125 enables respective users of computing device 120 to receive, view, hear, and respond to input, access applications, display content of online conversational exchanges, and perform available functions.

Service data app 127 is a mobile device application that is communicatively connected to service alignment program 200 on server 110. Service data app 127 receives service request information from service alignment program 200, including a presentation of the set of service requests associated with a respective technician. In some embodiments, the service request information reflects the information associated with service requests selected by the respective technician that has been determined to be appropriate for the respective technician's capability, location, and work history, as well as conditions associated with tools, parts, and materials available to the technician, and worksite conditions. In other embodiments, the service requests presented to the respective technician by service data app 127 are determined and assigned by service alignment program 200, and presented to the respective technician with an indication of a recommended order of performing the service requests, as well as navigation information to follow to travel to the service requests. In some embodiments, service data app 127 receives and stores service request information and continues to provide a display of service request information and navigation to the respective user, even if in a disconnected state from server 110. Service data app 127 can receive updates and input from the technician-user of computing device 120 via user interface 125 and synchronizes with service alignment program 200 when in a connected state with server 110.

Service request information 130 is a repository of information and details associated with each service request received. In some embodiments, service request information 130 may be a database associated with an asset management application (not shown). In other embodiments, service request information 130 is a listing of service requests and details of attributes of each service request. In an example embodiment, service request information 130 includes a category type of service, a location for the service to be performed, the asset(s) on which the service is to be performed, a timeframe in which the service is requested to be performed including a level of urgency, conditions of the worksite, and known tools, parts, and materials used as part of the service to be performed. An example may be, a maintenance service request, HVAC unit of building 10 on Main Street, security clearance is required, the maintenance requires new filter parts and a special calibration tool. Part of the maintenance service is performed outdoors on the building roof. Safety support straps are required.

Technician information 140 is a repository of information associated with respective technicians of a pool of technicians that perform service-related work activities of service requests received from customers and clients. Participating technicians provide and opt-in consent and approval of data and information collected and maintained in technician information 140, and used by service alignment program 200. Technician information 140 includes information about each technician's qualifications, certifications, education levels and courses, one or more areas of service expertise, skill level, work history, tool training, and technician location. Information regarding qualifications and certifications may include records of training completion or experience based on work history. Skill levels may be self-assessments, third-party assessments, or demonstrated attainment of documented standardized skill levels. In some embodiments, technician work history includes a number of service instances performed, type of service performed, asset type, brand, model, asset class, worksites, service duration, first-time fix rate, special tools, parts, or materials used, and results of service performed, including feedback from customers. Technician information 140 is accessed by service alignment program 200 to compare and align certain service requests as appropriate for the respective technician's capabilities, experience, and match with conditions and requirements of the service request tasks and worksite.

Tool inventory tracker 160 is a repository of tools that are allocated to each technician and tracks whether the tools are with the technician. In some embodiments, tool inventory tracker 160 tracks the location of one or more toolboxes allocated to a respective technician, by a transmitting device attached to the toolboxes. In some embodiments, tool inventory tracker 160 tracks the location of special tools that are used for certain service request tasks, such as special calibration tools or diagnostic tools. Tool inventory tracker 160 provides location information of tools to service alignment program 200 to determine whether a special tool required for a particular service request is present in the vehicle for a technician designated to perform the service request, based on a transmitting device attached to the special tool or a smart-tool feature of the special tool. Based on the location of a special tool used for a particular service request, service alignment program 200 may alter the order of performing service requests of the respective technician and may navigate the technician to obtain the special tool prior to performing the service request.

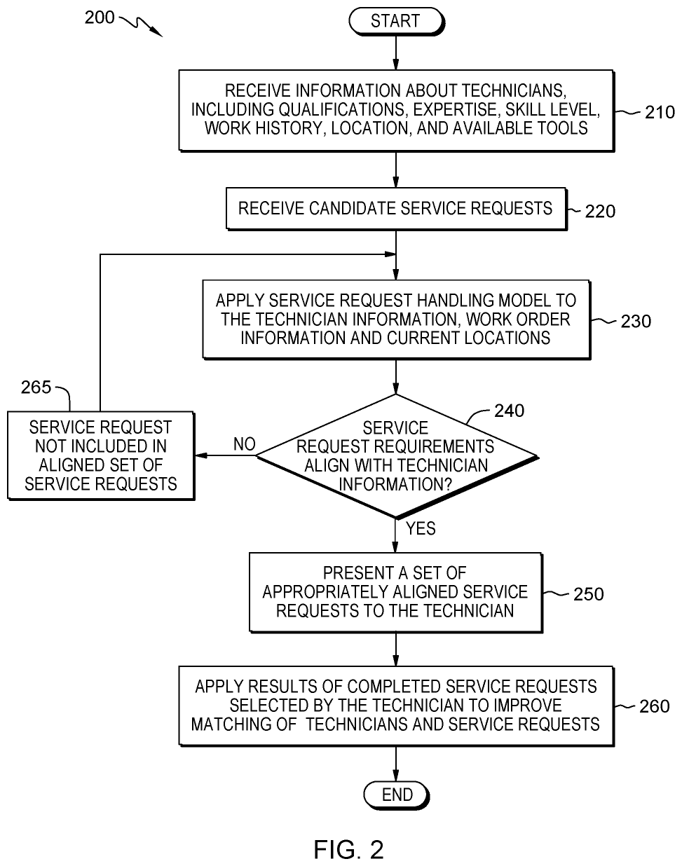

FIG. 2 is a flowchart depicting the operational steps of service alignment program 200 operating in the distributed data processing environment of FIG. 1, in accordance with embodiments of the present invention.

In some embodiments, the machine learning model tailored to the technician may be a component module of service alignment program 200 (not shown). The machine learning model generates a set of service request assignments determined as appropriate for a respective technician of a pool of technicians and includes predicted time to complete, priority, tools required, payout estimate, service site conditions, and technician location. In some embodiments, the service request assignments are displayed on a map representation presented to the technician on mobile computing device 120. In other embodiments, the machine learning model may reside remotely and be communicatively connected to service alignment program 200.

Service alignment program 200 receives information about technicians, including qualifications, expertise, skill level, work history, and available tools (step 210). For a respective technician of a plurality of technicians providing services for work requests from customers, service alignment program 200 receives information about the area(s) of expertise of the technician, the level of skill and experience, the assets on which the technician has provided service, which may include asset class, asset type, brands and models of assets. In some embodiments of the present invention, the information about the technician includes the technician's location, service work history, worksites at which the technician has performed services, efficiency measurements such as first-time fix rate for an asset or asset class, and special tools on which the technician is trained or retains in possession.

For example, service alignment program 200 receives information about technician A from technician information 140. The information acknowledges that technician A has expertise in HVAC maintenance, repair, and installations. The information indicates that the technician has 10 years of experience, and has an expert or master skill level. The information further includes that the technician works out of the south side of city XYZ and has worked previously at 3 government and one military facility. Technician A is certified on HVAC calibration tools and has such a tool in his possession (service truck), based on additional information from tool inventory tracker 160.

Service alignment program 200 receives candidate service requests (step 220). Service alignment program 200 receives service requests that include details about each respective service request. The service request details include information regarding the location at which the service is to be performed, the type of service, the asset(s) requiring service, whether the service is indoors or outdoors, a customer indication of urgency, safety and environmental hazards (if any), security protocols, and tool requirements. In some embodiments, service request details may be developed based on multiple prior service engagements.

Service alignment program 200 applies a service request handling model to the technician information, service request candidate information, and locations (step 230). The technician information and service request information of prior service engagements is used to construct and train a service request handling model, which is a machine learning generated model that links service request information to technician information to create the best fit for service performance and efficiency. In some embodiments, the service request handling model is a module component of service alignment program 200. In other embodiments, the service request handling model is a stand-alone model that communicates with service alignment program 200 to receive technician and service request information and performs comparisons, matching, and alignment of the elements of the technician and service request information.

In some embodiments, the service request handling model determines asset types and service types requested within the service request information and aligns the requests with technician information indicating expertise and experience with the same asset types and performing the service types. Additionally, the service request handling model considers worksite conditions and requirements included in the service request information and checks for technician information that includes experience or previous service experience matching the site conditions or service performed at the worksite. Location information for the technician and the work site are compared, as well as special tools that may be needed for performing the service.

For example, service alignment program 200, applies the information from technician information 140 and the information from service request information 130 to a service request handling model component of service alignment program 200. The model determines the expertise areas of a set of technicians as including HVAC, plumbing, electrical, and computer networks. Service alignment program 200 further determines technician experience with assets, brands, and models, whether the technician skills include repairs, maintenance, and/or installations, the experience of service performance from work history, and the location of the technician. Service alignment program 200 aligns the service request information to best match the attributes determined from the technician information, matching instances of service requests to individual technicians.

Service alignment program 200 determines whether service request requirements align with technician information (decision step 240). Service alignment program 200 determines whether there are one or more discrepancies between the technician and service request information sets. For example, if the service request involves servicing an asset with which a technician has no expertise or experience, service alignment program 200 identifies a discrepancy. For the case in which service alignment program 200 determines that the service request requirements do not align with the information of a respective technician of a plurality of technicians (step 240, “NO” branch), service alignment program 200 does not include the service request in a set of service requests aligned with the respective technician (step 265). Service alignment program 200 proceeds from step 265 to apply the service handling model to the technician information and additional service requests at step 230 and continues to process as described above.

For example, if service alignment program 200 determines that a service request includes conditions and/or requirements that do not align with the information about a particular technician or conditions associated with the service request, then service alignment program 200 does not include the service request instance in a set of service requests presented to the particular technician. For example, service alignment program 200 determines that the particular technician is not qualified, has limited or no experience servicing a particular type of asset, or the service request requires a special tool that is not available or weather conditions that make an outdoor service request too risky.

In some embodiments, if service alignment program 200 determines that a service request is not appropriate for a particular technician, then service alignment program 200 does not include the service request in a set of service requests presented to the particular technician. In other embodiments, service alignment program 200 includes the service request determined to be inappropriate for the particular technician but provides evidence explaining that the service request is not an appropriate match for the technician.

For the case in which service alignment program 200 determines that a service request's requirements align with the information of a respective technician of a plurality of technicians (step 240, “YES” branch), service alignment program 200 includes the service request in a set of service requests aligned with the respective technician and presents the set of appropriately aligned service requests to the respective technician (step 250).

In some embodiments of the present invention, service alignment program 200 displays the set of service requests in a user interface of a mobile computing device of the technician. In some embodiments, the display is a map representation that includes the location points of each service request of the set of service requests presented to the technician. In some embodiments, service alignment program 200 includes navigation information and prioritization of the service requests in the display of service requests on the mobile computing device. In some embodiments, service alignment program 200 includes additional information of a service request, subsequent to the technician selecting the service request from the display. Service alignment program 200 includes a recommended order in which the set of service requests are to be performed, optimizing travel, time, and factors such as tool requirements and weather conditions.

For example, service alignment program 200, having compared service request information with technician information, presents a set of five service requests to technician A, indicating the service requests are appropriately matched to technician A's expertise, experience, work history, and other factors. Service alignment program 200 presents a map representing the area in which the five service requests are located, with each service request identified and a priority number indicating the recommended order in which the service requests are to be performed. Service alignment program 200 includes navigation information and may include other information, such as estimated completion times of each service request, conditions associated with the service request, and payout of performing the service of each service request.

Service alignment program 200 applies the results of the completed service requests that are selected by the technician to improve the matching of technician and service request information (step 260). Service alignment program 200 receives input from the technician regarding the status and completion of the service request. The input may include the tasks completed, the time required to perform the service, the parts, materials, and tools needed to perform the service, and additional information and conditions, such as potential future service that is estimated to be required. The input received by service alignment program 200 may include information of problems or difficulties associated with the service request, such as extended diagnosis or repair time, requiring additional technical support, or unplanned part replacement.

For example, technician A completes the service request and inputs on computing device 120, using user interface 125 that displays input screens of service data app 127, the description of the problem found, the time required to perform the service, parts, and materials used, tools required, and conditions at the worksite.

Having received the input associated with the completion or status of a service request, service alignment program 200 continues to present the set of remaining service requests to the technician. Having received input for the set of service requests, or indication of completion by the technician, service alignment program 200 ends.

For further clarity of the features of embodiments of the present invention, an additional example is provided.

Eli is a field technician that specializes in fixing HVAC units. He uses an asset management application augmented with service alignment program 200 to view available work orders from his mobile device. This allows him to see open work orders while on the job. Equipped with a mobile device communicating with the asset management application and service alignment program 200, Eli pulls up a map view of the available service request work orders within the system. Eli begins to click “add to route” to plan his day. He adds a first service request work order (1) and a second service request work order (2). However, there is another service request listed that indicates that the service request does not appear to be an expertise match for Eli. Eli does not select this service request. The second service request work order requires that Eli have a special wrench that he does not have on the truck. So service alignment program 200 suggests that Eli focus on the other work item (1) and come back to the second service request work order after his lunch break when can drive back to the office to have his lunch and retrieve the special wrench. Eli adds service request 1 to his before lunch route. This allows Eli to obtain the wrench and be equipped to perform the service task for service request 2. His map is updated to reflect his priorities.

FIG. 3 depicts a block diagram of components of computing system 300, including computing device 305, configured to include or operationally connect to components depicted in FIG. 1, and with the capability to operationally perform service alignment program 200 of FIG. 2, in accordance with an embodiment of the present invention.

Computing device 305 includes components and functional capability similar to components of server 110 and mobile computing device 120 (FIG. 1), in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 305 includes communications fabric 302, which provides communications between computer processor(s) 304, memory 306, persistent storage 308, communications unit 310, an input/output (I/O) interface(s) 312. Communications fabric 302 can be implemented with any architecture designed for passing data and/or control information between processors (such as microprocessors, communications, and network processors, etc.), system memory, peripheral devices, and any other hardware components within a system. For example, communications fabric 302 can be implemented with one or more buses.

Memory 306, cache memory 316, and persistent storage 308 are computer-readable storage media. In this embodiment, memory 306 includes random access memory (RAM) 314. In general, memory 306 can include any suitable volatile or non-volatile computer-readable storage media.

In one embodiment, service alignment program 200 is stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of distributed data processing environment 100. In these examples, communications unit 310 includes one or more network interface cards. Communications unit 310 may provide communications through the use of either or both physical and wireless communications links. Service alignment program 200 may be downloaded to persistent storage 308 through communications unit 310.

I/O interface(s) 312 allows for input and output of data with other devices that may be connected to computing system 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., service alignment program 200 can be stored on such portable computer-readable storage media and can be loaded onto persistent storage 308 via I/O interface(s) 312. I/O interface(s) 312 also connects to a display 320.

Display 320 provides a mechanism to display data to a user and may, for example, be a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus, or the other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for aligning appropriate service requests to a technician as a provider of services, the method comprising:
receiving, by one or more processors, information about a technician, wherein the information about the technician includes a capability to perform a service instance and a location of the technician;
receiving, by the one or more processors, a plurality of service request candidates in which respective service requests include information associated with the respective service requests;
identifying, by the one or more processors, a first set of service requests appropriate for the technician by comparing the information about the technician and the location of the technician to the information associated with the respective service requests of the plurality of service request candidates;
determining, by the one or more processors, a recommended order to perform the first set of service requests by the technician, based on a distance between service request locations and an urgency of performing a service request; and
presenting, by the one or more processors, a respective location and the recommended order of service request response for the first set of service requests to the technician.

2. The method of claim 1, wherein the identifying of the first set of service requests appropriate for the technician, further comprises:
generating, by the one or more processors, a service alignment model tailored to the technician, based on applying a machine learning (ML) analysis of the capability of the technician to perform the service instance, wherein the capability of the technician is determined by a history of previously performed service instances, documented qualifications, physical assets associated with the service request, an area of expertise, and a skill level in the area of expertise of the technician;
applying, by the one or more processors, the service alignment model tailored to the technician to the plurality of service request candidates; and
determining, by the one or more processors, the respective service requests of the first set of service requests that include the assets, the service request locations, the area of expertise, and the skill level that aligns with the technician, based on the application of the service alignment model.

3. The method of claim 1:
wherein the information associated with the respective service requests of the first set of service requests is downloadable to a mobile device,
wherein the information associated with the respective service requests is accessible when offline and the technician can continue to work with secure data stored on the mobile device, and
wherein the information associated with the respective service requests is synchronized when the mobile device is online.

4. The method of claim 1, further comprising:
generating, by the one or more processors, a navigational sequence corresponding to the recommended order in which the first set of service requests are performed; and
presenting, by the one or more processors, the navigational sequence with the locations of the respective service requests along with the recommended order of performing the first set of service requests.

5. The method of claim 4, further comprising:
generating, by the one or more processors, an update to the navigational sequence to include an opportunity to acquire a tool for a service request of the first set of service requests.

6. The method of claim 1, wherein the information associated with the respective service requests of the plurality of service request candidates includes one or a combination selected from a group consisting of: a location at which a service of the respective service request is performed, an asset and information about the asset on which the service is performed, a type of service to perform, conditions associated with the location at which the service is performed, tools for performing the service, and a determination of whether the service is performed outdoors or indoors.

7. The method of claim 1, wherein the recommended order in which the order of the first set of service requests are performed by the technician is based on determining weather conditions associated with a location at which a service request is performed.

8. A computer program product for aligning appropriate service requests to a technician as a provider of services, the computer program product comprising:
one or more computer-readable storage media, and program instructions stored on the one or more computer-readable storage media, the program instructions comprising:
program instructions to receive information about a technician, wherein the information about the technician includes a capability to perform a service instance and a location of the technician;
program instructions to receiving a plurality of service request candidates in which respective service requests include information associated with the respective service requests;
program instructions to identify a first set of service requests appropriate for the technician by comparing the information about the technician and the location of the technician to the information associated with the respective service requests of the plurality of service request candidates;
program instructions to determine a recommended order to perform the first set of service requests by the technician, based on a distance between service request locations and an urgency of performing a service request; and
program instructions to present a respective location and the recommended order of service request response for the first set of service requests to the technician.

9. The computer program product of claim 8, wherein the identifying of the first set of service requests appropriate for the technician, further comprises program instructions, stored on the one or more computer readable storage media, to:
generate a service alignment model tailored to the technician, based on applying a machine learning (NIL) analysis of the capability of the technician to perform the service instance, wherein the capability of the technician is determined by a history of previously performed service instances, documented qualifications, physical assets associated with the service request, an area of expertise, and a skill level in the area of expertise of the technician;
apply the service alignment model tailored to the technician to the plurality of service request candidates; and
determine the respective service requests of the first set of service requests that include the assets, locations, the area of expertise, and the skill level that align with the technician, based on the application of the service alignment model.

10. The computer program product of claim 8, wherein information associated with respective service requests of the first set of service requests are downloadable to a mobile device, and wherein the information is accessible when offline and the technician can continue to work with secure data stored on the mobile device, and wherein the information associated with the respective service requests is synchronized when the mobile device is online.

11. The computer program product of claim 8, wherein a navigational sequence corresponding to the recommended order in which the first set of service requests are performed is presented along with the locations of the respective service requests and the recommended order of performing the first set of service requests.

12. The computer program product of claim 11, further comprising program instructions, stored on the one or more computer readable storage media, to:
generate a navigational sequence corresponding to the recommended order in which the first set of service requests are performed; and
present the navigational sequence with the locations of the respective service requests along with the recommended order of performing the first set of service requests.

13. The computer program product of claim 8, wherein the information associated with the respective service requests of the plurality of service request candidates includes one or a combination selected from a group consisting of: a location at which a service of the respective service request is performed, an asset and information about the asset on which the service is performed, a type of service to perform, conditions associated with the location at which the service is performed, tools for performing the service, and a determination of whether the service is performed outdoors or indoors.

14. The computer program product of claim 8, wherein the recommended order in which the order of the first set of service requests are performed by the technician is based on determining weather conditions associated with a location at which a service request is performed.

15. A computer system for aligning appropriate service requests to a technician as a provider of services, the computer program product comprising:
one or more computer processors;
one or more computer-readable storage media, and program instructions stored on the one or more computer-readable storage media, the program instructions comprising:
program instructions to receive information about a technician, wherein the information about the technician includes a capability to perform a service instance and a location of the technician;
program instructions to receiving a plurality of service request candidates in which respective service requests include information associated with the respective service requests;
program instructions to identify a first set of service requests appropriate for the technician by comparing the information about the technician and the location of the technician to the information associated with the respective service requests of the plurality of service request candidates;
program instructions to determine a recommended order to perform the first set of service requests by the technician, based on a distance between service request locations and an urgency of performing a service request; and
program instructions to present a respective location and the recommended order of service request response for the first set of service requests to the technician.

16. The computer system of claim 15, wherein the identifying of the first set of service requests appropriate for the technician further comprises program instructions, stored on the computer readable storage media for execution by at least one of the one or more processors, to:
generate a service alignment model tailored to the technician, based on applying a machine learning (ML) analysis of the capability of the technician to perform the service instance, wherein the capability of the technician is determined by a history of previously performed service instances, documented qualifications, physical assets associated with the service request, an area of expertise, and a skill level in the area of expertise of the technician;
apply the service alignment model tailored to the technician to the plurality of service request candidates; and
determine the respective service requests of the first set of service requests that include the assets, locations, the area of expertise, and the skill level that align with the technician, based on the application of the service alignment model.

17. The computer system of claim 15:
wherein the information associated with the respective service requests of the first set of service requests is downloadable to a mobile device,
wherein the information associated with the respective service requests is accessible when offline and the technician can continue to work with secure data stored on the mobile device, and
wherein the information associated with the respective service requests is synchronized when the mobile device is online.

18. The computer system of claim 15, further comprising program instructions, stored on the computer readable storage media for execution by at least one of the one or more processors, to:
generate a navigational sequence corresponding to the recommended order in which the first set of service requests are performed;
present the navigational sequence with the locations of the respective service requests along with the recommended order of performing the first set of service requests; and
update the navigational sequence to include an opportunity to acquire a tool for a service request of the first set of service requests.

19. The computer system of claim 15, wherein the information associated with the respective service requests of the plurality of service request candidates includes one or a combination selected from a group consisting of: a location at which a service of the respective service request is performed, an asset and information about the asset on which the service is performed, a type of service to perform, conditions associated with the location at which the service is performed, tools for performing the service, and a determination of whether the service is performed outdoors or indoors.

20. The computer system of claim 15, wherein the recommended order in which the order of the first set of service requests are performed by the technician is based on determining weather conditions associated with a location at which a service request is performed.
